(19) United States
(12) Patent Application Publication
(10) Pub. No.: US 2006/0138091 A1
(43) Pub. Date: Jun. 29, 2006

(54) Method of manufacturing zinc-coated electrode wire for electric discharge processors using hot dip galvanizing process

(76) Inventor: Jong-Cho Lee, Anyang-Si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/540,324

(22) PCT Filed: May 7, 2003
(86) PCT No.: PCT/KR03/00901

§ 371 Date: Dec. 30, 2005

(30) Foreign Application Priority Data
Dec. 24, 2002 (KR) 10-2002-0083330

(51) Int. Cl. B23H 7/08

(52) U.S. Cl. 219/69.12

(57) ABSTRACT

Disclosed is a method of manufacturing a zinc-coated electrode wire for electro discharge machining using a hot dip galvanizing process. The method includes firstly surface-forming a wire (1) in such a way that its terminal end is tapered while the wire is drawn through a first die at step 10, pre-coating zinc around the firstly processed wire in a molten zinc bath (2) at step 20, main-coating the pre-coated wire with zinc (3) using a sizing die before zinc pre-coated on the wire is hardened at step 30, secondly surface-forming the main-coated wire in such a way that zinc coated around the wire has a uniform thickness using a second die having a smaller diameter than the wire at step 40, heat-treating the secondly surface-processed wire at step 50, and drawing the heat-treated wire using a third die (5) made of natural diamond at step 60.

### TECHNICAL FIELD

The present invention relates to methods of manufacturing an electrode wire, which is useful as a cutting tool of a workpiece, using a hot dip galvanizing process. More specifically, the present invention is directed to a method of manufacturing a zinc-coated electrode wire for electro discharge machining using a hot dip galvanizing process, by subjecting a wire to the series of processes of firstly surface-forming, pre-coating, main-coating, secondly surface-forming, heat-treating and drawing, which is advantageous in terms of uniformly coating zinc on the wire by the hot dip galvanizing process, and thus reducing manufacturing cost, thereby achieving economic benefits. In addition, environmental contamination by harmful gas and wastewater inevitably generated according to conventional methods can be prevented by the present invention. Further, increase of both of thickness and adhesion of a zinc-coated layer results in decreasing generation of waste powder upon practical use of the wire, therefore improving the entire functions of the electrode wire.

### BACKGROUND ART

In general, so-called electro discharge machining (hereinafter, referred to as “EDM”) is a well-known technique for the accurate machining of a metallic workpiece by arc heat upon electro discharge. As shown in FIG. 9, when high voltage is applied between a workpiece and an electrode, large quantities of electrons flow close to the workpiece and arc discharge takes place. Thereby, the workpiece can be machined to a desired shape.

With great advances in the relevant industries, such EDM has been widely used to machine hardened materials that are difficult or impossible to machine by other conventional methods.

The EDM using a wire type electrode material is known to be a wire-cut EDM. In particular, the wire-cut EDM is effective for machining of small workpieces having complex geometries, such as tools or dies. However, when the workpiece is continuously machined with the electrode wire while being applied with voltage, the end portion of the wire is exhausted and thus such a wire cannot be reused after electro discharge.

Further, heat generated by electro discharge may cause breakage of the electrode wire. Thus, a brass wire alloyed with zinc (Zn) is mainly used to decrease internal heat with vaporization of an electrode material with high vapor pressure upon electro discharge. Use of such a brass wire leads to improvement of electro discharge effect, but is restricted by solid-solution limitations of conventional alloys. That is, the maximum content of zinc solid-soluble in a phase (FCC) constituting a coating layer amounts to about 39% at 456° C.

Although a copper wire is mainly used as an electrode wire for wire electro discharge machining, it is low in tensile strength. Hence, high tension cannot be applied to the wire, and it is difficult to restrain vibration of the electrode wire upon electro discharge machining, causing rough machining of the workpiece and easy breakage of the wire. In addition, workability of electro discharge machining of copper per se is not good and a machining speed becomes slow.

Therefore, a brass electrode wire made of copper-zinc alloy is adaptable to increase the machining speed.

That is, as the content of zinc on the brass electrode wire increases, the machining speed becomes faster. This is because zinc functions to cause explosive electro discharge and efficiently remove molten portions of the workpiece. Thereby, the workpiece is hardly attached with contaminants.

As mentioned above, the higher the content of zinc, the higher the workability of electro discharge machining. However, the wire is lowered in drawability.

In other words, when the coating layer contains more than 40% zinc exceeding 40%, it is composed of a needle-like structure, and β phase having high hardness is formed therein. Thus, a drawing process is difficult to perform.

Therefore, the electrode wire is coated with a brass layer having as high Zn content as possible within the limitation of drawability, so as to increase the machining speed and realize the accurate machining of the workpiece. In practical use, only a portion of several μm thick from the surface of the wire affects electro discharge machining. Even though the same brass wire is used, workability of the electro discharge machining varies according to the manufacturing method of such a brass wire.

The brass electrode wire on which zinc is coated is manufactured by various processes, for example, electroplating, hot dip galvanizing, plasma coating and thermal spraying, in which the plasma coating process and the thermal spraying process are disadvantageous in terms of high manufacturing cost, and thus are scarcely used.

In addition, the hot dip galvanizing process is advantageous in light of low manufacturing cost, and no generation of harmful gas and wastewater, thus causing no environmental problems, but suffers from drawbacks, such as change of characteristics of the brass wire upon passing through a bath consisting primarily of zinc molten at high temperature, and formation of the coating layer having non-uniform composition.

Although having the above-mentioned advantages, the hot dip galvanizing process is not practically used for preparation of the electrode wire for electro discharge machining, and is limitedly used only for a corrosion resistant coating process.

The reason why the hot dip galvanizing process is not practically used is that a surface temperature of the wire should be close to the melting point of zinc so that the molten zinc is uniformly coated around the wire, because of surface tension of the molten zinc. Accordingly, the surface temperature of the wire is increased to perform the coating process, whereby zinc in the brass electrode wire is coated on the wire while being deposited.

As such, a diffusion reaction takes place, transferring a metal from high concentration portion to a low concentration portion. Thereby, zinc concentration on the wire differs from that in the wire.

Further, since a diffused layer formed on the wire is composed of not a uniform zinc composition but a non-uniform alloy composition, the hot dip galvanizing process is unsuitable for preparation of a zinc-coated electrode wire.

Moreover, the electrode wire is peeled during performing the electro discharge machining. In such a case, properties of the wire when the discharge machining is initiated vary from those of the wire when the discharge machining is terminated, attributable to different properties between the surface and the inside of the coating layer. Thus, it is difficult to uniformly perform the electro discharge machining by use of the electrode wire manufactured by the hot dip galvanizing process.

Therefore, the electroplating process, which is based on a principle of coating zinc ions in a coating solution to a surface of a wire by electrical force, is mainly used to perform a zinc coating process on the brass electrode wire. As a result, the zinc-coated layer having uniform zinc composition is formed on the wire and thickness of such a layer is easily controllable.

However, the electroplating process is disadvantageous in light of high manufacturing cost, generation of hazardous gases and wastewater, thus negatively affecting the environment.

Thus, manufacturing methods of the zinc-coated brass electrode wire without the above problems are urgently required.

### DISCLOSURE OF THE INVENTION

Therefore, it is an object of the present invention to alleviate the problems encountered in the related art and to provide a method of manufacturing a zinc-coated electrode wire for electro discharge machining by use of a hot dip galvanizing process, by subjecting a wire to the series of processes of firstly surface-forming, pre-coating, main-coating, secondly surface-forming, heat-treating and drawing. The inventive method is advantageous in terms of formation of uniformly coated zinc on the wire as in an electroplating process even through the hot dip galvanizing process is used, resulting in low manufacturing cost, thereby achieving economic benefits. In addition, environmental contamination problems by harmful gas and wastewater inevitably generated according to conventional methods can be prevented. Further, increase of thickness and adhesion of a zinc-coated layer leads to decreased generation of waste powder, thus improving the entire functions of the electrode wire.

In order to achieve the above object, the present invention provides a method of manufacturing a zinc-coated electrode wire for electro discharge machining using a hot dip galvanizing process, the method comprising the following steps of firstly surface-forming a wire so that its terminal end is tapered while the wire is drawn through a first die; pre-coating the firstly surface-processed wire with zinc by passing the wire through a molten zinc bath at a relatively slow speed; main-coating the pre-coated wire with zinc, wherein the wire is immersed in the molten zinc bath for a predetermined time to maintain the temperature of zinc pre-coated on the wire at a predetermined level, and is removed from the molten zinc bath and then passed through a sizing die preheated to 400° C. before zinc coated on the wire is hardened, so that zinc coated on the wire has a predetermined thickness; secondly surface-forming the main-coated wire by passing the wire through a heated pipe at a constant speed to raise a surface temperature of the wire to a predetermined level, and then passing the wire through a second die having a diameter of 5-10 μm smaller than that of the wire so that zinc is coated around the wire at a uniform thickness; homogeneously heat-treating the secondly surface-processed wire in a closed space by hot air circulating therein; and drawing the homogeneously heat-treated wire with a drawing ratio of 4-80 or higher by passing the wire through a third die made of natural diamond and having an inlet portion of 5 μm across, a middle portion of 3 μm across and an outlet portion of 1˜3 μm across to make the surface of the wire smooth, provided that the homogeneously heat-treated wire has a sectional area of 0.3˜3 mm².

### BRIEF DESCRIPTION OF THE DRAWINGS

Further objects, features and advantages of the present invention will be more clearly understood from the following detailed description taken in conjunction with the accompanying drawings, in which:

FIG. 1 is a view illustrating overall processes of a method of manufacturing a zinc-coated electrode wire for electro discharge machining using a hot dip galvanizing process, according to the present invention;

FIG. 2 is a view illustrating a coating process by use of a molten bath in the method of manufacturing a zinc-coated electrode wire for electro discharge machining using a hot dip galvanizing process, according to the present invention;

FIG. 3 is a photograph illustrating the wire subjected to a firstly surface-forming process in the method of manufacturing a zinc-coated electrode wire for electro discharge machining using a hot dip galvanizing process, according to the present invention;

FIG. 4 is a photograph illustrating the wire subjected to a pre-coating process in the method of manufacturing a zinc-coated electrode wire for electro discharge machining using a hot dip galvanizing process, according to the present invention;

FIG. 5 is a photograph illustrating the wire subjected to a main-coating process in the method of manufacturing a zinc-coated electrode wire for electro discharge machining using a hot dip galvanizing process, according to the present invention;

FIG. 6 is a photograph illustrating the wire subjected to a secondly surface-forming process in the method of manufacturing a zinc-coated electrode wire for electro discharge machining using a hot dip galvanizing process, according to the present invention;

FIG. 7 is a photograph illustrating the wire subjected to a homogeneously heat-treating process in the method of manufacturing a zinc-coated electrode wire for electro discharge machining using a hot dip galvanizing process, according to the present invention;

FIG. 8 is a view illustrating a main portion of a die used for a drawing process in the method of manufacturing a zinc-coated electrode wire for electro discharge machining using a hot dip galvanizing process, according to the present invention; and

FIG. 9 is a view illustrating use of the zinc-coated electrode wire for electro discharge machining using a hot dip galvanizing process, according to the present invention.

### BEST MODE FOR CARRYING OUT THE INVENTION

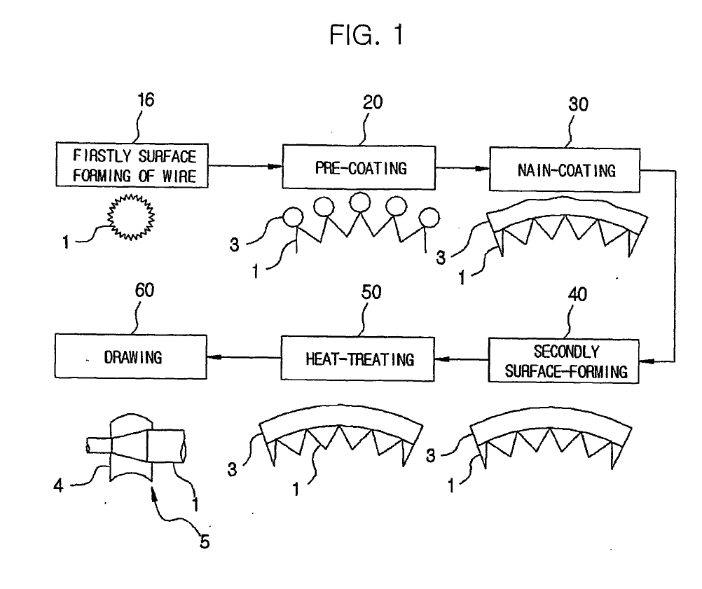

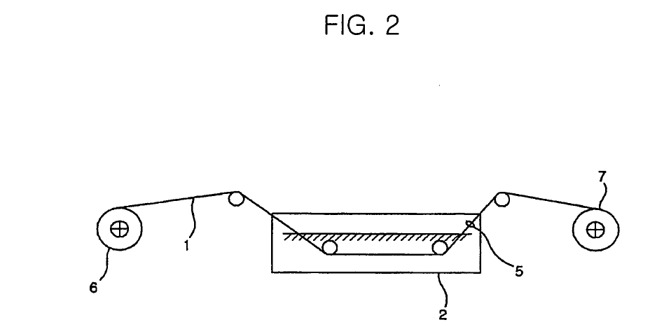

With reference to FIG. 1, there is illustrated a manufacturing method of a zinc-coated electrode wire for electro discharge machining using a hot dip galvanizing process, according to the present invention. In addition, FIG. 2 schematically illustrates a coating process by use of a molten bath, according to the manufacturing method of the zinc-coated electrode wire for electro discharge machining using a hot dip galvanizing process.

In the present invention, a specific description for the related techniques or structures is considered to be unnecessary and thus is omitted.

Further, before the manufacturing method of the present invention is disclosed, it should be understood that the terminology used therein is for the purpose of describing particular embodiments only and is not intended to be limiting.

As shown in FIG. 1, a wire 1 is firstly surface-processed in such a way that its terminal end is tapered while the wire 1 is drawn through a first die, at step 10. The firstly surface-processed wire 1 is pre-coated with zinc 3 at step 20, by passing through a molten zinc bath 2 heated to 440-500° C. at a relatively slow speed of 30-40 m/min so that the wire 1 is immersed in the molten zinc bath 2 for 1˜2 sec. As such, the firstly surface-processed wire 1 has a sectional area of 0.3˜3 mm².

Then, the pre-coated wire 1 is main-coated with zinc 3 at step 30, by passing through the molten zinc bath 2 heated to 430˜480° C. at 50-70 m/min so that the wire 1 is immersed in the molten zinc bath 2 for 1-2 sec. In such a case, zinc 3 pre-coated around the wire 1 is at a temperature of 410±10° C. Immediately after the wire 1 on which zinc 3 is coated is removed from the molten zinc bath 2, it passes through a sizing die preheated to 400° C. before a zinc-coated layer formed on the wire 1 is hardened. Thereby, the zinc-coated layer is formed on the wire at a predetermined thickness.

Thereafter, the main-coated wire 1 is secondly surface-processed at step 40, by passing through a 4˜6 m long pipe heated to 400° C. at 30˜50 m/min so that a surface temperature of the wire 1 reaches 250-350° C., and by passing through a second die having a diameter of about 5-10 μm smaller than that of the wire 1. Thereby, zinc 3 coated around the wire 1 has a uniform thickness.

The secondly surface-processed wire 1 is homogeneously heat-treated by hot air of 120˜180° C. circulating at 10˜20 m/sec in a closed space, at step 50. Then, the heat-treated wire 1 is drawn at step 60, by passing through a third die 5 made of natural diamond 4 and having an inlet portion of 5 μm across, a middle portion of 3 μm across and an outlet portion of 1-3 μm across, provided that the homogeneously heat-treated wire 1 has a sectional area of 0.3˜3 mm². Consequently, the electrode wire 1 having smooth surface and thin thickness can be obtained.

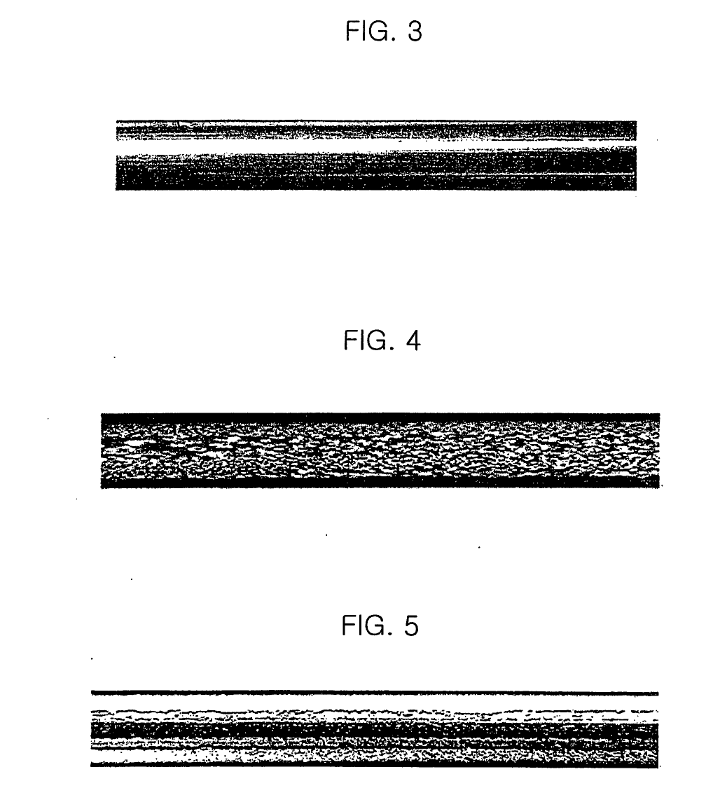

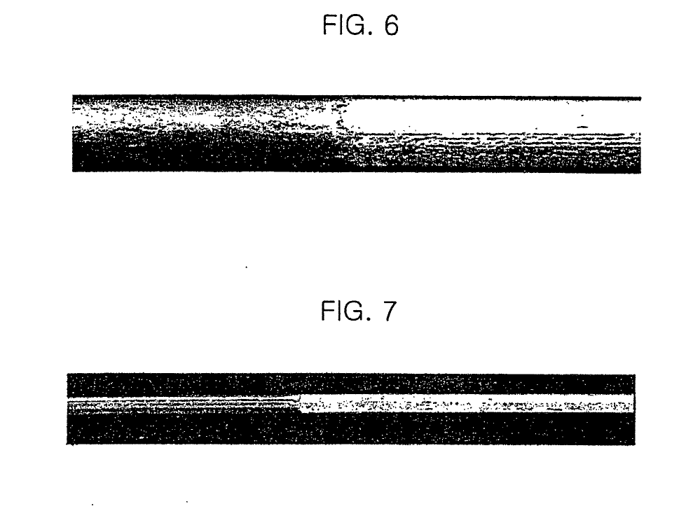

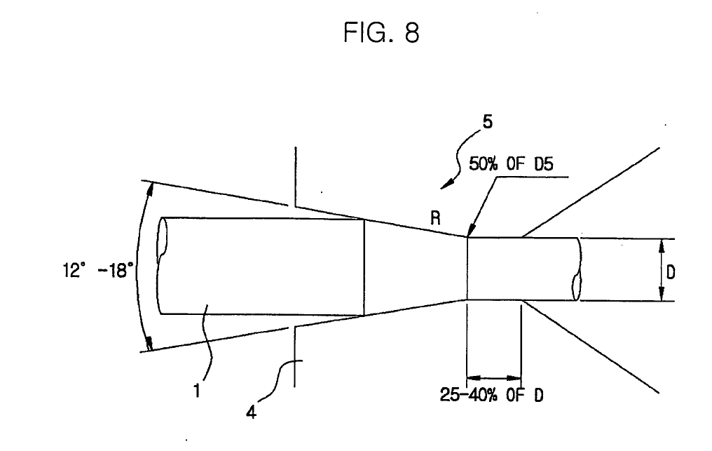

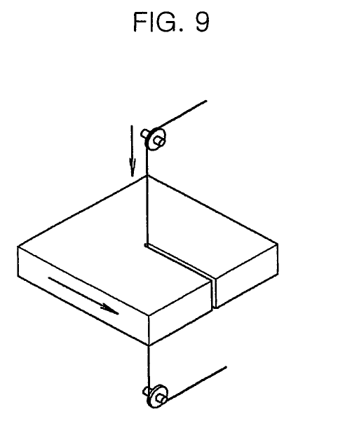

Turning now to FIG. 3, there is shown a photograph of the firstly surface-processed wire according to the method of manufacturing the zinc-coated electrode wire for electro discharge machining using the hot dip galvanizing process. In addition, FIG. 4 illustrates a photograph of the pre-coated wire according to the method of manufacturing the zinc-coated electrode wire for electro discharge machining using the hot dip galvanizing process. Further, FIGS. 5 and 6 illustrate photographs of the main-coated wire and the secondly surface-processed wire, respectively, according to the method of manufacturing the zinc-coated electrode wire for electro discharge machining using the hot dip galvanizing process. Furthermore, FIG. 7 illustrates a photograph of the homogeneously heat-treated wire according to the method of manufacturing the zinc-coated electrode wire for electro discharge machining using the hot dip galvanizing process. Also, FIG. 8 illustrates the third die used for the drawing process according to the method of manufacturing the zinc-coated electrode wire for electro discharge machining using the hot dip galvanizing process.

As mentioned above, the zinc-coated electrode wire is manufactured by subjecting the wire to a series of the processes of firstly surface-forming, pre-coating, main-coating, secondly surface-forming, heat-treating and drawing. Thereby, the electrode wire for electro discharge machining can be uniformly coated with zinc at an outer surface thereof even by the hot dip galvanizing process, as in electroplating process.

Specifically, as for the firstly surface-forming process at step 10, the wire 1 is surface-processed in such a way that its terminal end is tapered as shown in FIG. 3, while the wire 1 is drawn through the first die. Thereby, a diffusion reaction by high temperatures takes place only at the tapered end of the wire 1 upon passing through the molten zinc bath 2.

Hence, diffusion phenomena of a brass electrode wire at high temperatures are minimized, and thus volume of the electrode wire is changed minimally.

Subsequently, as for the pre-coating process at step 20, the firstly processed wire 1 passes through the molten zinc bath 2 heated to 440˜500° C. at a relatively slow speed of 30˜40 m/min when it has a sectional area of 0.3˜3 mm², so that the wire 1 is immersed in the molten zinc bath 2 for 1-2 sec. Thereby, zinc 3 is coated around the wire 1, as shown in FIG. 4.

As such, if the immersion time of the wire is shorter than 1˜2 sec, the diffusion reaction of the wire does not occur and thus the coating process cannot be effectively carried out. Meanwhile, if the immersion time is longer than 1˜2 sec, the diffusion reaction occurs excessively, thus forming a diffused layer with extremely wide area and thick layer thickness, causing a non-uniformly coated wire.

As for the main-coating process at step 30, the wire 1 pre-coated at step 20 passes through the molten zinc bath 2 heated to 430˜480° C. at 50˜70 m/min so that the wire 1 is immersed in the molten zinc bath 2 for 1˜2 sec. Thereby, the temperature of zinc 3 coated around the wire 1 reaches 410±10° C. Immediately after such a wire 1 is removed from the molten zinc bath 2, it passes through the sizing die preheated to 400° C. before the zinc 3 coated on the wire is hardened, whereby zinc 3 is coated around the wire 1 at a predetermined thickness, as shown in FIG. 5.

Next, as for the secondly surface-forming process at step 40, the main-coated wire 1 passes through a 4-6 m long pipe heated to 400° C. at 30˜50 m/min to reach the surface temperature of the wire 1 250˜350° C., and then passes through the second die having a diameter of about 5˜10 μm smaller than that of the wire 1. Thereby, zinc 3 is uniformly coated on the wire 1, as shown in FIG. 6.

As for the homogeneously heat-treating process at step 50, the secondly surface-processed wire 1 is placed into a closed space, and is homogeneously heated by the hot air of 120˜180° C. circulating at 10-20 m/sec therein, as shown in FIG. 7.

Such a heat-treating process is performed with the intention of improving low adhesion of zinc 3 coated on the surface-formed wire 1 as well as increasing stability of zinc particles per se.

Through the heat-treating process, a diffused layer about 1 μm thick is formed at a contact surface between the wire 1 and zinc 3 coated on the wire 1, whereby the zinc-coated layer can be firmly bonded to the wire 1. Further, zinc 3 on the electrode wire 1 is converted to zinc oxide, and causes the wire to have high rigidity. Accordingly, the electrode wire of the present invention has no conventional problems, such as generation of waste powder and breakage of the wire as in the drawing process of conventional electrode wires coated with only zinc.

As for the drawing process at step 60, the heat-treated wire 1 passes through the third die 5 made of natural diamond 4 and having an inlet portion of 5 μm across, a middle portion of 3 μm across and an outlet portion of 1˜3 μm across, as shown in FIG. 8, to manufacture a smooth and thin electrode wire, provided that the homogeneously heat-treated wire 1 has a sectional area of 0.3˜3 mm².

In particular, upon performing the drawing process of the wire with a drawing ratio of 4-80 or higher, such a diamond die 5 having an inlet portion of 5 μm, a middle portion of 3 μm and an outlet portion of 1˜3 μm is favorable so as to preserve the bonded state of zinc coated on the wire, which is unstable due to very different physical properties of the wire and zinc on the wire.

After the drawing process, final heat treatment and product manufacturing processes are the same as conventional methods and description thereof is omitted.

### INDUSTRIAL APPLICABILITY

As described above, the present invention provides a method of manufacturing a zinc-coated electrode wire for electro discharge machining using a hot dip galvanizing process, and the method is characterized by subjecting a wire to firstly surface-forming, pre-coating, main-coating, secondly surface processing, uniformly heat-treating and drawing treatments. Even though the hot dip galvanizing process is used, the wire can be uniformly coated with zinc at an outer surface thereof as in an electroplating process. Thereby, the inventive method is advantageous in terms of decreased manufacturing cost, thus generating economic benefits.

In addition, the inventive method is very effective for prevention of environmental contamination due to noxious gases and wastewater generated by conventional manufacturing methods.

Further, the electrode wire manufactured by the inventive method is improved in adhesion between the wire and zinc coated thickly thereon, and thus decreases generation of waste powder upon practical use thereof. Consequently, the electrode wire can be enhanced in overall functions thereof.

The present invention has been described in an illustrative manner, and it should be understood that the terminology used is intended to be in the nature of description rather than of limitation. Many modifications and variations of the present invention are possible in light of the above teachings. Therefore, it should be understood that within the scope of the appended claims, the invention may be practiced otherwise than as specifically described.

1. A method of manufacturing a zinc-coated electrode wire for electro discharge machining using a hot dip galvanizing process, the method comprising the following steps of:
firstly surface-forming a wire so that a terminal end of the wire is tapered while the wire is drawn through a first die;
pre-coating the firstly surface-processed wire with zinc by passing the wire through a molten zinc bath at a relatively slow speed;
main-coating the pre-coated wire with zinc, wherein the pre-coated wire is immersed in the molten zinc bath for a predetermined time to maintain the temperature of zinc pre-coated on the wire at a predetermined level, and is removed from the molten zinc bath and then passed through a sizing die preheated to 400° C. before zinc coated on the wire is hardened, so that zinc coated on the wire has a predetermined thickness;
secondly surface-forming the main-coated wire by passing the wire through a heated pipe at a constant speed to raise a surface temperature of the wire to a predetermined level, and then passing the wire through a second die having a diameter of 5˜10 μm smaller than that of the wire so that zinc is coated around the wire at a uniform thickness;
homogeneously heat-treating the secondly surface-processed wire in a closed space by hot air circulating therein; and
drawing the homogeneously heat-treated wire with a drawing ratio of 4˜80 or higher by passing the wire through a third die made of natural diamond and having an inlet portion of 5 μm across, a middle portion of 3 μm across and an outlet portion of 1˜3 μm across to make the surface of the wire smooth, provided that the homogeneously heat-treated wire has a sectional area of 0.3˜3 mm².

2. The method as defined in claim 1, wherein, at the pre-coating step, the firstly surface-processed wire passes through the molten zinc bath heated to 440˜500° C. at a relatively slow speed of 30˜40 m/min when the wire has a sectional area of 0.3˜3 mm², so that the wire is immersed in the molten zinc bath for 1˜2 sec.

3. The method as defined in claim 1, wherein, at the main-coating step, the pre-coated wire passes through the molten zinc bath heated to 430˜480° C. at 50˜70 m/min so that the wire is immersed in the molten zinc bath for 1˜2 sec.

4. The method as defined in claim 1, wherein, at the secondly surface-forming step, the main-coated wire passes through the pipe heated to 400° C. at 30˜50 m/min, so that the surface temperature of the wire reaches 250 350° C.

5. The method as defined in claim 1, wherein, at the homogeneously heat-treating step, the secondly surface-processed wire is heated by the hot air of 120˜180° C. circulating at 10˜20 m/sec in the closed space.
